(19) United States
(12) Patent Application Publication
(10) Pub. No.: US 2026/0342366 A1
(43) Pub. Date: Oct. 29, 2026

(54) MULTIPLEXING TRANSVERTER AND SERIAL INTERFACE

(71) Applicant: BAE Systems Information and Electronic Systems Integration Inc., Nashua, NH (US)

(72) Inventors: Robert J. Thompson, Cedar Rapids, IA (US); Nicholas J. Schaub, Marion, IA (US); David P. Spinden, Cedar Rapids, IA (US); Frank J. Sgroi, Marion, IA (US); Matthew E. Haller, Springville, IA (US)

(73) Assignee: BAE Systems Information and Electronic Systems Integration Inc., Nashua, NH (US)

(21) Appl. No.: 19/187,582

(22) Filed: Apr. 23, 2025

(51) Int. Cl. H04B 1/00; H04B 7/0426; H04L 5/14; H04L 27/12

(52) U.S. Cl. CPC H04B 1/0096; H04B 1/0057; H04B 7/043; H04L 5/14; H04L 27/12

(57) ABSTRACT

Multiplexing transverters and a serial interface using same. A system implementing the techniques according to an embodiment includes a first multiplexing transverter coupled to a second multiplexing transverter via a serial coupling. The first multiplexing transverter is configured to provide full duplex communication, over the serial coupling, to the second multiplexing transverter, the communication comprising transmission of encoded beamformer status and beamformed data streams, and reception of encoded beamformer control parameters and direct current (DC) voltage. The second multiplexing transverter is configured to provide full duplex communication, over the serial coupling, to the first multiplexing transverter, the communication comprising reception of the encoded beamformer status and the beamformed data streams, and transmission of the encoded beamformer control parameters and the DC voltage. In some embodiments, the serial coupling may be a coaxial cable.

### FIELD OF DISCLOSURE

The present disclosure relates to system interfaces, and more particularly to a multiplexing transverter and a serial interface employing same.

### BACKGROUND

Many navigation systems, including global navigation satellite system (GNSS), receive satellite signals through an antenna assembly that may comprise one or more antennas. These signals are then transmitted through a cable to receiver electronics that decode the signals and generate navigation data. In some applications, the antenna is located on the outside of a platform, such as a ground vehicle, ship, or aircraft, or other mobile platform, while the receiver is located inside the platform. As such, a penetration is required through a wall of the platform in which to run the cable. In some applications, particularly military applications, stringent requirements may exist that can make it challenging to deploy equipment upgrades requiring modifications to the cable and/or the penetration point.

### BRIEF DESCRIPTION OF THE DRAWINGS

FIG. 1 illustrates a serial interface application, in accordance with certain embodiments of the present disclosure.

FIG. 2 is a block diagram of a serial interface system, configured in accordance with certain embodiments of the present disclosure.

FIG. 3 illustrates a down-mixing frequency allocation, in accordance with certain embodiments of the present disclosure.

FIG. 4 illustrates an up-mixing frequency allocation, in accordance with certain embodiments of the present disclosure.

FIG. 5 is a block diagram of the external multiplexing transverter of FIG. 2, configured in accordance with certain embodiments of the present disclosure.

FIG. 6 is a block diagram of the internal multiplexing transverter of FIG. 2, configured in accordance with certain embodiments of the present disclosure.

FIG. 7 is a block diagram of the serializer circuit of FIG. 5, configured in accordance with certain embodiments of the present disclosure.

FIG. 8 is a block diagram of the deserializer circuit of FIG. 6, configured in accordance with certain embodiments of the present disclosure.

FIG. 9 is a flowchart illustrating a methodology for operation of the external multiplexing transverter of FIG. 2, in accordance with an embodiment of the present disclosure.

FIG. 10 is a flowchart illustrating a methodology for operation of the internal multiplexing transverter of FIG. 2, in accordance with an embodiment of the present disclosure.

Although the following Detailed Description will proceed with reference being made to illustrative embodiments, many alternatives, modifications, and variations thereof will be apparent in light of this disclosure.

### DETAILED DESCRIPTION

Techniques are provided herein for a serial interface, which includes a multiplexing transverter. Many communications systems, including navigation systems (e.g., GNSS), receive radio frequency (RF) and/or satellite signals through an antenna assembly that may comprise one or more antennas. These signals may then be transmitted through a cable to receiver electronics that decode the signals and generate navigation data. In some applications, the antenna is located on the outside of a platform, such as a ground vehicle, ship, aircraft, or other mobile platform, while the receiver is located inside the platform. As such, a penetration is required through a wall of the platform in which to run the cable. In some applications, particularly military applications, stringent requirements may exist that can make it challenging to deploy equipment upgrades requiring modifications to the cable and/or the penetration point.

To this end, and in accordance with an embodiment of the present disclosure, a serial interface that includes a multiplexing transverter architecture is provided which can operate in a full duplex serial communication mode that is capable of multiplexing multiple signals, along with direct current (DC) voltage for power, over a serial coupling such as a coaxial cable or other serial coupling that uses a single wire or conductor to transmit data (not counting any ground and/or shielding conductors which electrically support communication over that single wire). The serial interface allows systems at either end of the interface to be swapped out and upgraded without requiring changes to the serial coupling or the penetration points. For example, a fixed reception pattern antenna (FRPA) external to the platform that communicates over a coaxial cable with a receiver inside the platform could be replaced with a controlled reception pattern antenna (CRPA) and anti-jamming (AJ) system that performs beam steering and null steering, without requiring upgrades to the cabling to accommodate the more complex data flow.

In accordance with an embodiment, a serial interface is provided, which can be used, for instance, for GNSS and communications applications. A system including the interface may include, for instance, a first multiplexing transverter coupled to a second multiplexing transverter via a serial coupling. The serial coupling may have a single conductor (e.g., single wire) for passage of data between the first and second transverters. Full duplex serial communication is provided through concurrent operation of the first and second multiplexing transverters. The first multiplexing transverter is configured to provide full duplex communication, over the serial coupling, to the second multiplexing transverter, the communication comprising, for instance, transmission of encoded beamformer status and beamformed data streams, and reception of encoded beamformer control parameters and DC voltage. The second multiplexing transverter is configured to provide full duplex communication, over the serial coupling, to the first multiplexing transverter, the communication comprising, for instance, reception of the encoded beamformer status and the beamformed data streams, and transmission of the encoded beamformer control parameters and the DC voltage. In some embodiments, the serial coupling may be a coaxial cable, wherein data is communicated between the first and second transverters via a single center conductor of the coaxial cable.

It will be appreciated that the techniques described herein may provide improved capabilities to upgrade systems at opposite ends of an interface that runs through a platform housing, compared to other methods that require new cabling. Numerous embodiments and applications will be apparent in light of this disclosure.

### System Architecture

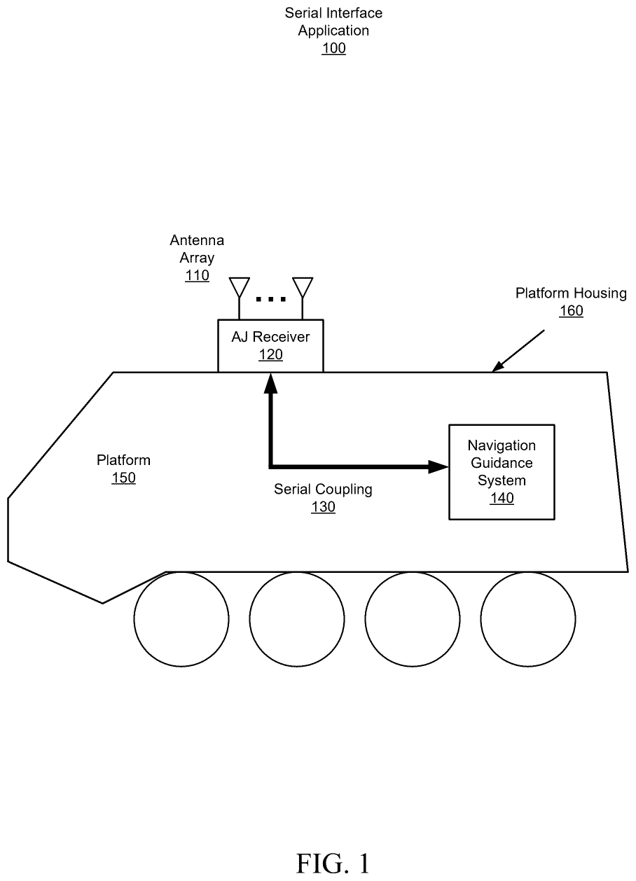

FIG. 1 illustrates a serial interface application 100, in accordance with certain embodiments of the present disclosure. A platform 150 is shown, which in this example is a military vehicle such as a tank or armored ground vehicle. In general, the platform may be any type of vehicle, ship, aircraft, or enclosure, whether mobile or stationary. The platform has a skin or housing 160 which may be armored plating or any other suitable material. An antenna array 110 and an AJ receiver 120 are shown on the outside of the platform 150 (e.g., external to the housing 160). In some embodiments, the antenna array 110 may be a CRPA antenna. A navigational guidance system 140 is shown inside the platform 150 (e.g., internal to the housing 160). A serial coupling 130 is shown to provide an electrical connection between the AJ receiver 120 and the navigational guidance system 140. In some embodiments, the serial coupling may be a coaxial cable comprising an inner conductor and an outer shield.

In some embodiments, the AJ receiver 120 is configured to receive signals from the plurality of antennas of the antenna array 110. The AJ receiver may then form beams in the directions of signals of interest and nulls in the directions of jammer sources, using any suitable techniques. In some embodiments, the AJ receiver 120 may be an AJ GNSS receiver and the beams are steered towards GNSS satellites, or an AJ communications receiver and the beams are steered towards communication satellites or other sources. More generally, the techniques provided herein can be used with any type of data transmission system that may employ antennas for receiving and/or transmitting data. Data streams associated with each formed beam may then be transmitted over the serial coupling 130 to the navigational guidance system 140. In some embodiments, data for up to 24 beams may be transmitted over the serial coupling 130. Other data, for example, AJ receiver status and built-in-test results, may also be transmitted over the serial coupling 130 to the navigational guidance system 140. Additionally, power for operation of the AJ receiver 120 may be provided over the serial coupling 130.

In some embodiments, the navigational guidance system 140 is configured to receive the beam data (e.g., the data streams associated with each formed beam), and any other provided data, over the serial coupling 130. The navigational guidance system 140 is configured to process the beam data to generate navigation and guidance information such as time, position, velocity, etc. for the platform 150, using any suitable techniques. In some embodiments, the navigational guidance system 140 may also generate control data and configuration parameters for transmission to the AJ receiver 120 over the serial coupling 130. Examples of control data and configuration parameters may include commands to configure the number of beams to be generated and/or to perform built-in-test, etc.

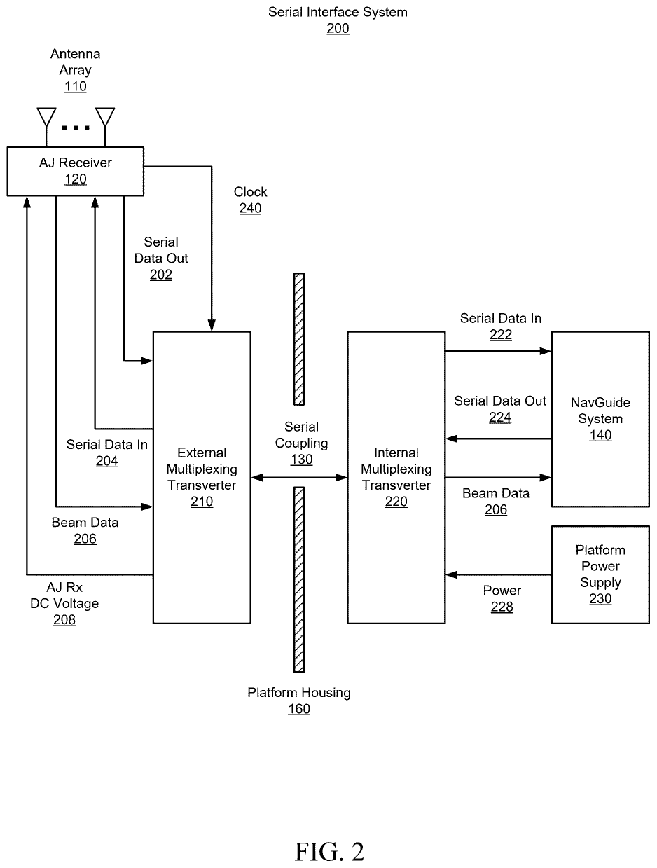

FIG. 2 is a block diagram of a serial interface system 200, configured in accordance with certain embodiments of the present disclosure. The system 200 is shown to include the antenna array 110, the AJ receiver 120, an external multiplexing transverter 210, the serial coupling 130, an internal multiplexing transverter 220, the navigation guidance system 140, and a platform power supply 230.

Operation of the external multiplexing transverter 210 will be described in greater detail below, but at a high level, the external multiplexing transverter 210 is configured to provide full duplex transmission of signals over the serial coupling 130. In some embodiments, the signals include a first serial data stream 202, a second serial data stream 204, beamformed data streams 206, and a DC voltage 208. The first serial data stream 202 may comprise encoded beamformer status that is output from the of the AJ receiver 120 for transmission over the serial coupling 130. The second serial data stream 204 may comprise encoded beamformer control parameters received via the serial coupling 130. The beamformed data streams 206 may comprise the beams (e.g., beamformer samples for each beam) formed by the AJ receiver 120 for transmission over the serial coupling 130. The DC voltage 208 supplies power to the AJ receiver 120 and is received via the serial coupling 130.

Operation of the internal multiplexing transverter 220 will be described in greater detail below, but at a high level, the internal multiplexing transverter 220 is also configured to provide full duplex transmission of signals over the serial coupling 130. In some embodiments, the signals include a first serial data stream 222, a second serial data stream 224, beamformed data streams 206, and power 228. The first serial data stream 222 may comprise encoded beamformer status that is received via the serial coupling 130 to be provided to the navigation guidance system 140. The second serial data stream 224 may comprise encoded beamformer control parameters that is output from navigation guidance system 140 for transmission over the serial coupling 130. The beamformed data streams 206 may comprise the beams received via the serial coupling 130 to be provided to the navigation guidance system 140. The power 228 is provided by the platform power supply 230 and is transmitted over the serial coupling 130.

In some embodiments, the serial interface system 120 described herein may be used in applications other than GNSS, for example to couple other types of systems that transmit and receive multiple signals and power via a serial coupling 130.

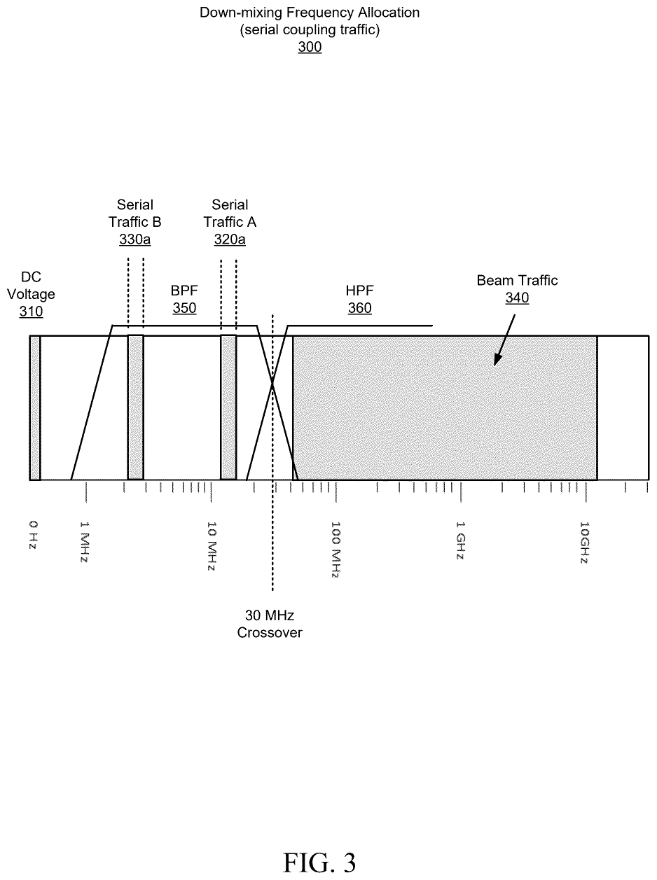

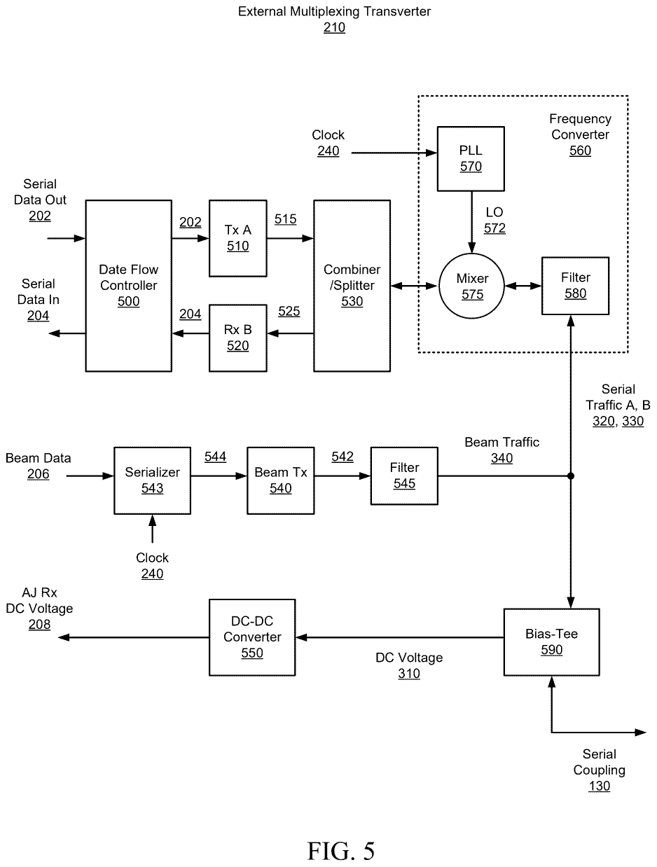

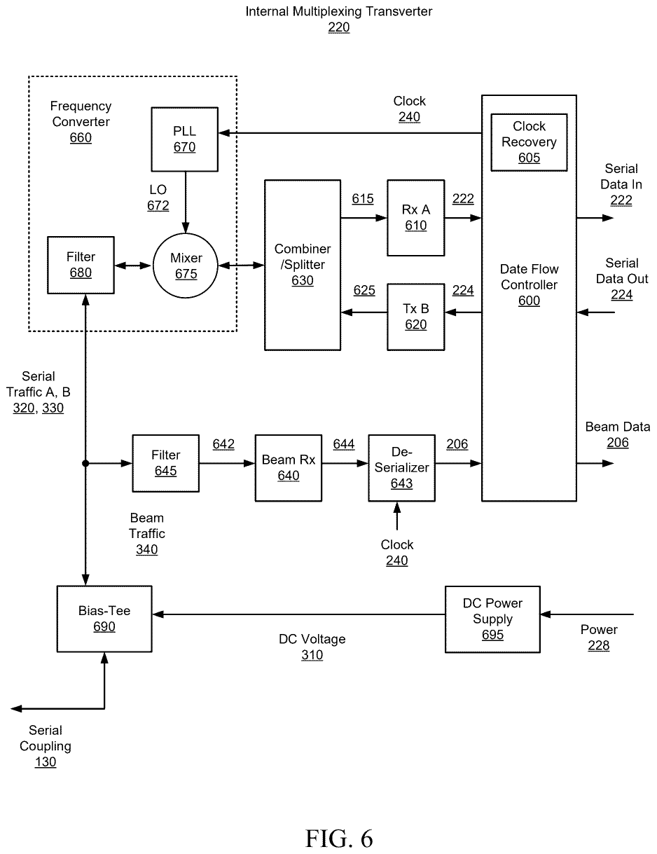

FIG. 3 illustrates a down-mixing frequency allocation 300, in accordance with certain embodiments of the present disclosure. The external multiplexing transverter 210 and internal multiplexing transverter 220 convert the data streams and power into traffic that is transmitted over the serial coupling 130. The conversion process will be described in greater detail below, in connection with FIGS. 5 and 6, however one part of the conversion process involves frequency conversions of the signals into allocated spectral regions. In one embodiment, as illustrated in this figure, the input and output serial data streams (202, 204, 224, 224) are mixed down in frequency from (915 MHz and 901 MHz) to occupy frequency bands labeled “serial traffic A” 320a (centered about 12 MHz) and “serial traffic B” 330a (centered about 2 MHz). The purpose of the down mixing is to move those serial data streams away from the beam traffic 340 (associated with the beamformed data streams 206) which occupies a broad frequency range extending from 40 MHz to 13 GHz. Band pass filter 350 is applied to serial traffic A and B, while high pass filter 360 is applied to the beam traffic. The DC voltage 310 which is transmitted over the serial coupling 130 is also shown at DC (0 Hz).

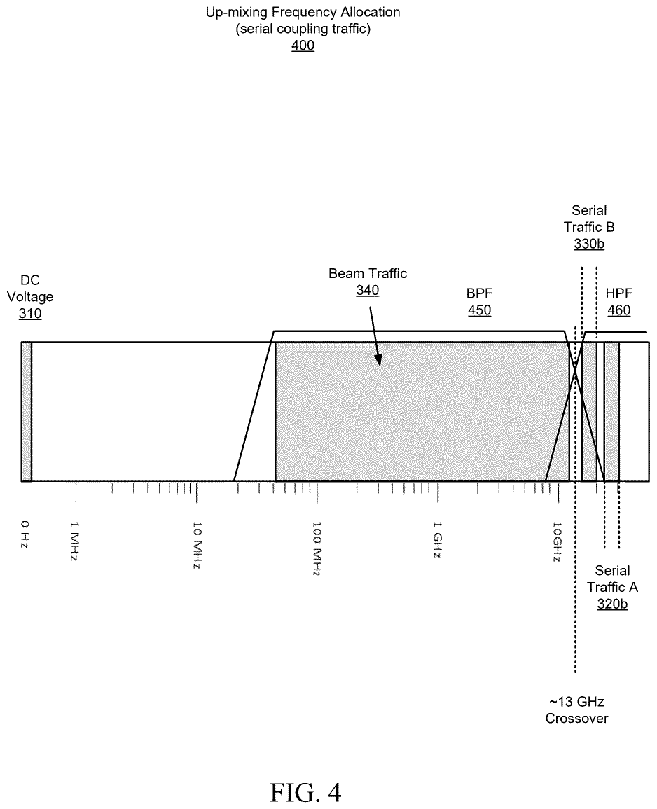

FIG. 4 illustrates an up-mixing frequency allocation 400, in accordance with certain embodiments of the present disclosure. As an alternative to the frequency allocation described above in connection with FIG. 3, in some embodiments, the input and output serial data streams (202, 204, 224, 224) are mixed up in frequency to occupy frequency bands labeled “serial traffic A” 320b (centered about 14 GHz) and “serial traffic B” 330b (centered about 15 GHz). Band pass filter 450 is applied to the beam traffic, while high pass filter 460 is applied to the serial traffic A and B.

FIG. 5 is a block diagram of the external multiplexing transverter 210 of FIG. 2, configured in accordance with certain embodiments of the present disclosure. The external multiplexing transverter 210 is shown to include a data flow controller 500, a first transceiver (Tx A) 510, a second transceiver (Rx B) 520, a combiner/splitter 530, a frequency converter 560, a serializer circuit 543, a third transceiver (beam Tx) 540, a filter 545, a DC-DC converter 550, and a Bias-Tee circuit 590.

The data flow controller 500 is configured to coordinate data flow with the AJ receiver 120, for example through handshaking protocols or any other suitable techniques.

The first transceiver (Tx A) 510 is configured to modulate a first serial bit stream 202 to generate a first modulated signal 515. In some embodiments, the first serial bit stream 202 comprises encoded beamformer status, which is received from the AJ receiver 120. In some, embodiments, the modulation is frequency shift keying (FSK) modulation.

The second transceiver (Rx B) 520 is configured to demodulate a second modulated signal 525 to generate a second serial bit stream 204. In some embodiments, the second serial bit stream 204 comprises encoded beamformer control parameters, which are provided to the AJ receiver 120. In some, embodiments, the demodulation is FSK demodulation.

The frequency converter 560 is configured to frequency convert the first modulated signal 515 to generate an output signal (e.g., serial traffic A 320) and to frequency convert an input signal (e.g. serial traffic B 330) to generate the second modulated signal 525. In some embodiments, the frequency converter is configured to convert frequencies such that the output signal and the input signal are out of band relative to the filtered modulated composite beamformer signal (e.g., beam traffic 340), as described below. The frequency converter 560 is shown to include a phase locked loop (PLL) frequency synthesizer 570, a mixer 575, and a filter 580.

The PLL frequency synthesizer 570 is configured to generate a local oscillator (LO) signal 572 based on a clock 240 supplied by the AJ receiver 120. In some embodiments, the clock signal is a 44 MHz frequency reference.

The mixer 575 is configured to mix the LO 572 with the first modulated signal 515 to frequency shift the signal away from the frequency band of the beam traffic 340. In some embodiments, that employ the down-mixing frequency allocation 300, the first modulated signal 515 is frequency shifted from 915 MHz down to 12 MHz (e.g., serial traffic A region 320a). In some embodiments, that employ the up-mixing frequency allocation 400, the first modulated signal 515 is frequency shifted from 915 MHz up to 14 GHz (e.g., serial traffic A region 320b).

The mixer 575 is also configured to mix the LO 572 with serial traffic B (after filtering by filter 580) to frequency shift the signal back to a pre-transmission frequency band. In some embodiments, that employ the down-mixing frequency allocation 300, the filtered serial traffic B is frequency shifted from 2 MHz (e.g., serial traffic B region 330a) up to 901 MHz. In some embodiments, that employ the up-mixing frequency allocation 400, the filtered serial traffic B is frequency shifted from 12 GHz (e.g., serial traffic B region 330b) down to 901 MHz.

The filter 580 is configured to apply the band pass filter 350 in embodiments that employ the down-mixing frequency allocation 300 and to apply the high pass filter 460 in embodiments that employ the up-mixing frequency allocation 400.

The combiner/splitter 530 is configured to direct the first modulated signal 515 from the first transceiver (Tx A) 510 into the mixer 575 and to direct the second modulated signal 525 out of the mixer 575 into to the second transceiver (Rx B) 520.

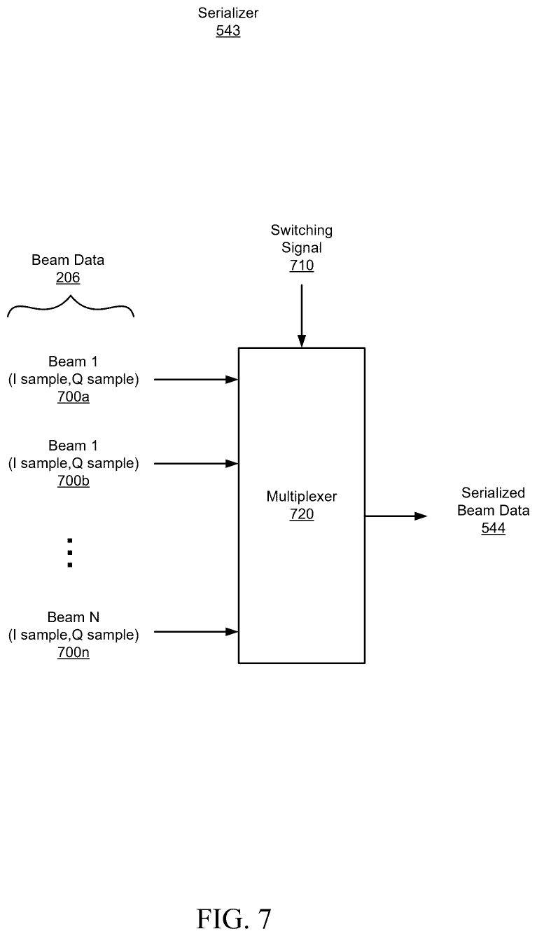

The serializer circuit 543 is configured to serialize the beamformed data streams 206 to generate serialized beam data 544. In some embodiments, the beamformed data streams 206 are received from the AJ receiver 120. Operation of the serializer circuit 543 will be described in greater detail below in connection with FIG. 7.

The third transceiver 540 is configured to modulate the serialized beam data 544 to generate a modulated composite beamformer signal 542. In some embodiments, the modulation is non-return-to-zero (NRZ) modulation.

The filter 545 is configured to filter the modulated composite beamformer signal 542 to generate beam traffic 340. The filter 545 is configured to apply the high pass filter 360 in embodiments that employ the down-mixing frequency allocation 300 and to apply the band pass filter 450 in embodiments that employ the up-mixing frequency allocation 400.

The Bias-Tee circuit 590 is configured to sum the output signal (e.g., serial traffic A 320) and the beam traffic 340 into a first composite signal for transmission over the serial coupling 130 and to extract the input signal (e.g. serial traffic B 330) and a DC voltage 310 from a second composite signal received on the serial coupling 130.

The DC-DC converter 550 is configured to convert the DC voltage 310 into a DC voltage 208 that is suitable for powering the AJ receiver 120. In some embodiments, AJ receiver 120 may require 40 watts of power for operation, which may be provided, for example at 40 volts and 1 ampere of current.

FIG. 6 is a block diagram of the internal multiplexing transverter 220 of FIG. 2, configured in accordance with certain embodiments of the present disclosure. The internal multiplexing transverter 220 is shown to include a data flow controller 600, a first transceiver (Rx A) 610, a second transceiver (Tx B) 620, a combiner/splitter 630, a frequency converter 660, a third transceiver (beam Rx) 640, a deserializer circuit 643, a filter 645, a DC power supply 695, and a Bias-Tee circuit 690. The data flow controller 600 is shown to include a clock recovery circuit 605.

The data flow controller 600 is configured to coordinate data flow with the navigation guidance system 140, for example through handshaking protocols or any other suitable techniques.

The first transceiver (Rx A) 610 is configured to demodulate a first modulated signal 615 to generate a first serial bit stream 222, which is provided to the navigational guidance system 140. In some embodiments, the first serial bit stream 222 comprises encoded beamformer status of the AJ receiver 120. In some, embodiments, the demodulation is FSK demodulation.

The second transceiver (Tx B) 620 is configured to modulate a second serial bit stream 224 to generate a second modulated signal 625. In some embodiments, the second serial bit stream comprises encoded beamformer control parameters, which are received from the navigational guidance system 140. In some, embodiments, the modulation is FSK modulation.

The frequency converter 660 is configured to frequency convert an input signal (e.g., serial traffic A 320) to generate the first modulated signal 615 and to frequency convert the second modulated signal 625 (e.g., the modulated second serial bit stream 224) to generate an output signal (e.g. serial traffic B 330). In some embodiments, the frequency converter is configured to convert frequencies such that the output signal and the input signal are out of band relative to the beam traffic 340, as described below. The frequency converter 660 is shown to include a PLL frequency synthesizer 670, a mixer 675, and a filter 680.

The PLL frequency synthesizer 670 is configured to generate an LO signal 672 based on the clock 240 supplied by the clock recovery circuit 605.

The mixer 675 is configured to mix the LO 672 with serial traffic A (after filtering by filter 680) to frequency shift the signal back to a pre-transmission frequency band to generate the first modulated signal 615. In some embodiments, that employ the down-mixing frequency allocation 300, the filtered serial traffic A is frequency shifted from 12 MHz (e.g., serial traffic A region 320a) up to 915 MHz. In some embodiments, that employ the up-mixing frequency allocation 400, the filtered serial traffic A is frequency shifted from 14 GHz (e.g., serial traffic A region 320b) down to 915 MHz.

The mixer 675 is also configured to mix the LO 672 with the second modulated signal 625 to frequency shift the signal away from the frequency band of the beam traffic 340. In some embodiments, that employ the down-mixing frequency allocation 300, the second modulated signal 625 is frequency shifted from 901 MHz down to 2 MHz (e.g., serial traffic B region 330a). In some embodiments, that employ the up-mixing frequency allocation 400, the second modulated signal 625 is frequency shifted from 901 MHz up to 12 GHz (e.g., serial traffic B region 330b).

The filter 680 is configured to apply the band pass filter 350 in embodiments that employ the down-mixing frequency allocation 300 and to apply the high pass filter 460 in embodiments that employ the up-mixing frequency allocation 400.

The combiner/splitter 630 is configured to direct the first modulated signal 615 out of the mixer 675 into to the first transceiver (Rx A) 610 and to direct the second modulated signal 625 from the second transceiver (Tx B) 620 into the mixer 675.

The filter 645 is configured to filter the beam traffic 340 to generate the modulated composite beamformer signal 642. The filter 645 is configured to apply the high pass filter 360 in embodiments that employ the down-mixing frequency allocation 300 and to apply the band pass filter 450 in embodiments that employ the up-mixing frequency allocation 400

The third transceiver 640 is configured to demodulate the modulated composite beamformer signal 642 to generate serialized beam data 644. In some embodiments, the demodulation is NRZ demodulation.

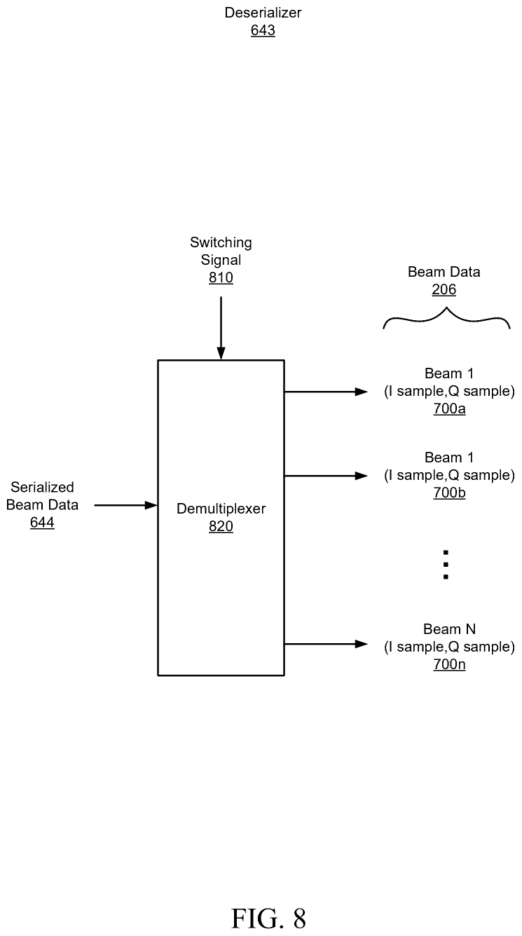

The deserializer circuit 643 is configured to deserialize the serialized beam data 644 to generate beamformed data streams 206. In some embodiments, the beamformed data streams 206 are provided to the navigation guidance system 140. Operation of the deserializer circuit 643 will be described in greater detail below in connection with FIG. 8.

The DC power supply 695 is configured to receive power 228 from an external power source (e.g., the platform power supply 230) and generate a DC voltage 310 based on that supplied power. In some embodiments, the DC voltage 310 maybe 40 volts at 1 amp of current.

The Bias-Tee circuit 690 is configured to sum the output signal (e.g. serial traffic B 330) and a DC voltage 310 into a first composite signal for transmission over the serial coupling 130; and to extract the input signal (e.g., serial traffic A 320) and the beam traffic 340 from a second composite signal received on the serial coupling 130.

The clock recovery circuit 605 is configured to extract the clock signal 240, using any suitable technique, from the beamformed data streams (e.g., the beam data 206) for use by the frequency converter 660 to synthesize the LO mixing signal 672. Use of the recovered clock signal 240 allows the internal multiplexing transverter to be synchronized with the external multiplexing transverter 210 providing frequency and phase lock to reduce bit error rates and data loss of the serial traffic 320, 330.

FIG. 7 is a block diagram of the serializer circuit 543 of FIG. 5, configured in accordance with certain embodiments of the present disclosure. The serializer circuit 543 comprises multiplexer 720 that is configured to select samples from each beam of the beam data 206, for example in a round robin fashion, to interleave and serialize the samples to generate the serialized beam data 544.

The beam data 206 is shown to include samples from N beams 700a, 700b, . . . 700n. Each sample is a complex value comprising an in-phase (I) sample and a quadrature phase (Q) sample. The stream of samples from the first beam 700a may be represented, for example, as:
B1 I1, B1Q1, B1 I2, B1 Q2, . . . , etc.
   where B1 I1 is the first I sample of beam 1, B1 Q1 is the first Q sample of beam 1, etc. Likewise, the stream of samples from the Nth beam 700n may be represented, for example, as:
BN I1, BN Q1, BN I2, BN Q2, . . . , etc.
   In some embodiments, then, the serialized data stream beam data 544 may be represented as:
B1 I1, B1 Q1, B2 I1, B2 Q1, . . . BN I1, BN Q1, B1 I2, B1 Q2, B2 I2, B2 Q2, . . . etc.

In some embodiments, the switching signal 710 may be derived from (e.g., proportional to) the clock signal 240. In some embodiments, the switching signal rate may be 132 MHz, the number of beams (N) may be 24, resulting in a bit rate of 2.6 Gigabits per second for the serialized data stream beam data 544.

FIG. 8 is a block diagram of the deserializer circuit 643 of FIG. 6, configured in accordance with certain embodiments of the present disclosure. The deserializer circuit 643 comprises demultiplexer 820 that is configured to take in samples from the serialized beam data 644 and deinterleave them to each of N beams of the beam data 206, for example in a round robin fashion, to deinterleave and deserialize the samples to generate the beams 700a, . . . 700n, of the beam data 206.

In some embodiments, then, the serialized data stream beam data 644 may be represented as:
B1 I1, B1 Q1, B2 I1, B2 Q1, . . . BN I1, BN Q1, B1 I2, B1 Q2, B2 I2, B2 Q2, . . . etc.
   The stream of samples from the first beam 700a may then be represented, for example, as:
B1 I1, B1Q1, B1 I2, B1 Q2, . . . , etc.
   and the stream of samples from the Nth beam 700n may be represented, for example, as:
BN I1, BN Q1, BN I2, BN Q2, . . . , etc.

In some embodiments, the switching signal 810 may be derived from (e.g., proportional to) the recovered clock signal 240.

Although the embodiments described herein refer to communication between an AJ receiver and a navigation guidance system, the disclosed techniques can be applied to other applications where full duplex communication over a serial coupling are required. The disclosed techniques may be applied to other such applications by adjusting frequencies, filter parameters, and modulation schemes to accommodate any given application.

### Methodology

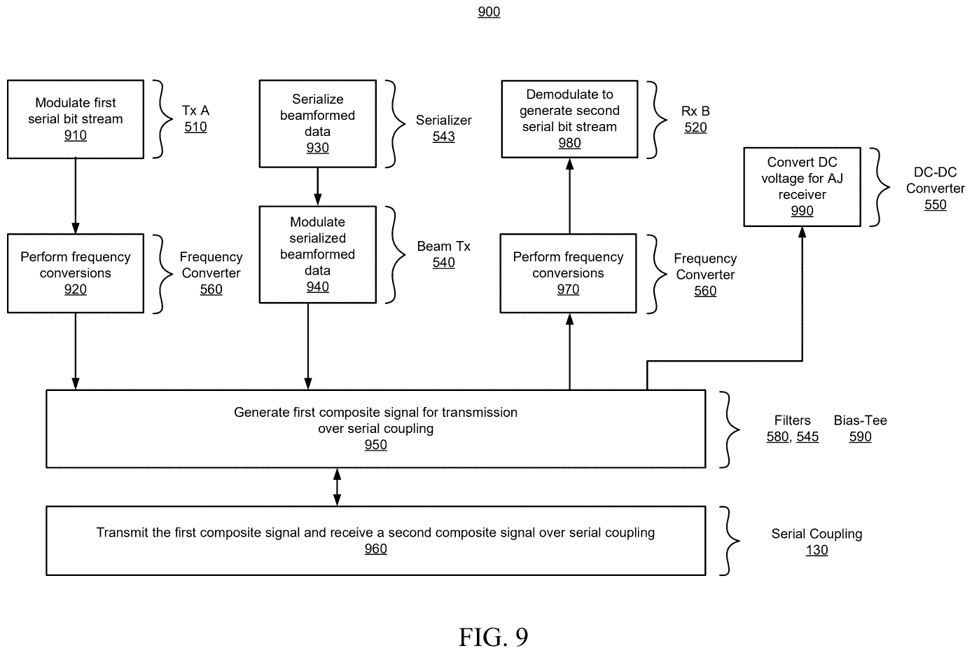

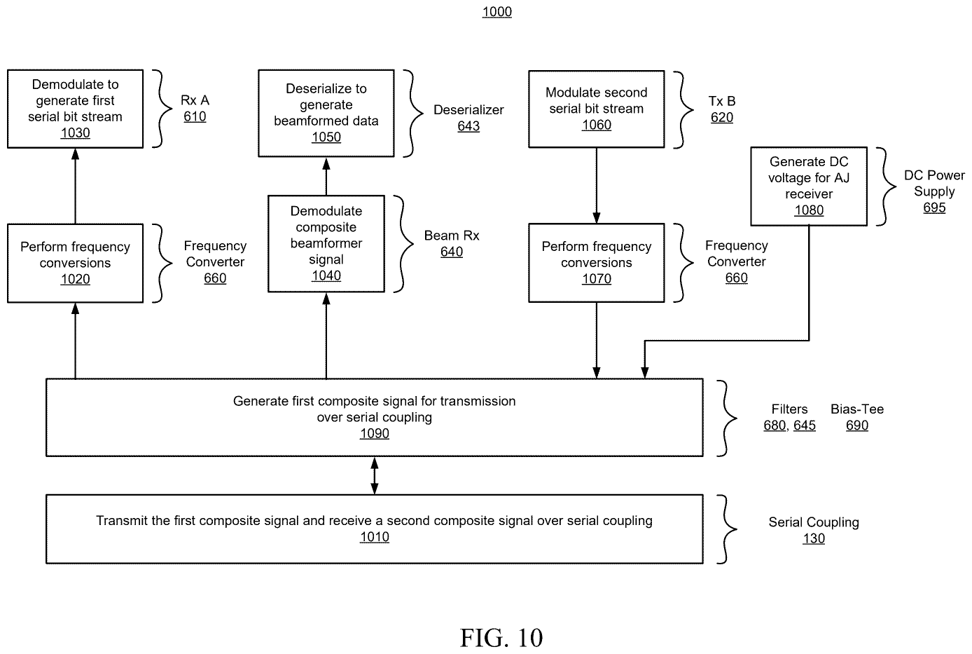

FIG. 9 is a flowchart illustrating a methodology 900 for operation of the external multiplexing transverter 210 of FIG. 2, in accordance with an embodiment of the present disclosure. FIG. 10 is a flowchart illustrating a methodology 1000 for operation of the internal multiplexing transverter 220 of FIG. 2, in accordance with an embodiment of the present disclosure. The transverters 210 and 220 are configured to operate in parallel to provide full duplex communication and so the methodologies 900 and 1000 may operate concurrently. As can be seen, example methods 900 and 1000 include a number of phases and sub-processes, the sequence of which may vary from one embodiment to another. However, when considered in aggregate, these phases and sub-processes form a process for operation of multiplexing transverters 210, 220, in accordance with certain of the embodiments disclosed herein, for example as illustrated in FIGS. 1-6, as described above. However other system architectures can be used in other embodiments, as will be apparent in light of this disclosure. To this end, the correlation of the various functions shown in FIGS. 9 and 10 to the specific components illustrated in the figures, is not intended to imply any structural and/or use limitations. Rather other embodiments may include, for example, varying degrees of integration wherein multiple functionalities are effectively performed by one system. Numerous variations and alternative configurations will be apparent in light of this disclosure.

In one embodiment, method 900 for operation of the external multiplexing transverter 210 commences, at operation 910, by modulating a first serial bit stream to generate a first modulated signal. In some embodiments, the first serial bit stream comprises encoded beamformer status. In some embodiments, the modulation is FSK modulation.

At operation 920, frequency conversion is performed on the first modulated signal to generate an output signal.

At operation 930, beamformed data streams are serialized.

At operation 940, the serialized streams are modulated to generate a modulated composite beamformer signal. In some embodiments, the modulation is NRZ modulation. In some embodiments, the frequencies are converted, at operation 920, such that the output signal and the input signal are out of band relative to the modulated composite beamformer signal.

At operation 950, the output signal and the modulated composite beamformer signal are summed into a first composite signal for transmission over a serial coupling.

At operation 960, the first composite signal is transmitted over the serial coupling and an input signal and a DC voltage are extracted from a second composite signal received on the serial coupling.

At operation 970, frequency conversion is performed on the input signal to generate a second modulated signal.

At operation 980, the second modulated signal is demodulated to generate a second serial bit stream. In some embodiments, the second serial bit stream comprises encoded beamformer control parameters. In some embodiments, the demodulation is FSK demodulation.

At operation 990, the DC voltage is converted to a level for use by the AJ receiver.

In some embodiments, additional operations may be performed, as previously described in connection with the system. For example, the first serial bit stream and the beamformed data streams may be received from the AJ receiver, while the second serial bit stream is provided to the AJ receiver.

Turning to methodology 1000, in one embodiment, method 1000 for operation of the internal multiplexing transverter 220 commences, at operation 1019, by transmitting a first composite signal over a serial coupling and extracting an input signal and a modulated composite beamformer signal from a second composite signal received on the serial coupling. Generation of the first composite signal is described below at operations 1060-1090.

At operation 1020, frequency conversion is performed on the input signal to generate a first modulated signal.

At operation 1030, the first modulated signal is demodulated to generate a first serial bit stream. In some embodiments, the first serial bit stream comprises encoded beamformer status. In some embodiments, the demodulation is FSK demodulation.

At operation 1040, the modulated composite beamformer signal is demodulated. In some embodiments, the demodulation is NRZ modulation. In some embodiments, the frequencies are converted, at operation 1030, such that the output signal and the input signal are out of band relative to the composite beamformer signal.

At operation 1050, the demodulated composite beamformer signal is deserialized to generate beamformed data streams.

At operation 1060, a second serial bit stream is modulated to generate a second modulated signal. In some embodiments, the second serial bit stream comprises encoded beamformer control parameters. In some embodiments, the modulation is FSK modulation.

At operation 1070, frequency conversion is performed on the second modulated signal to generate an output signal.

At operation 1080, a DC voltage is generated.

At operation 1090, the output signal and the DC voltage are summed into the first composite signal for transmission over the serial coupling as described above at operation 1010.

In some embodiments, additional operations may be performed, as previously described in connection with the system. For example, a clock signal may be extracted from the beamformed data streams to synthesize a local oscillator mixing signal for the frequency conversion operations. In some embodiments, the first serial bit stream and the beamformed data streams may be provided to the navigational guidance system, while the second serial bit stream is received from the navigational guidance system.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood, however, that other embodiments may be practiced without these specific details, or otherwise with a different set of details. It will be further appreciated that the specific structural and functional details disclosed herein are representative of example embodiments and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

Example 1 is a multiplexing transverter comprising a first transceiver configured to modulate a first serial bit stream to generate a first modulated signal; a second transceiver configured to demodulate a second modulated signal to generate a second serial bit stream; a frequency converter configured to frequency convert the first modulated signal to generate an output signal and to frequency convert an input signal to generate the second modulated signal; a third transceiver configured to serialize beamformed data streams and to modulate the serialized streams to generate a modulated composite beamformer signal; and a bias-tee circuit configured to sum the output signal and the modulated composite beamformer signal into a first composite signal for transmission over a serial coupling, and to extract the input signal and a direct current voltage from a second composite signal received on the serial coupling.

Example 2 includes the multiplexing transverter of Example 1, wherein the first serial bit stream comprises encoded beamformer status and the second serial bit stream comprises encoded beamformer control parameters.

Example 3 includes the multiplexing transverter of Examples 1 or 2, wherein the first transceiver is configured to perform frequency shift keying (FSK) modulation on the first serial bit stream, the second transceiver is configured to perform FSK demodulation on the second modulated signal, and the third transceiver is configured to perform non-return-to-zero (NRZ) modulation on the serialized streams.

Example 4 includes the multiplexing transverter of any of Examples 1-3, further comprising: a combiner/splitter configured to direct the first modulated signal from the first transceiver into a mixer of the frequency converter, and to direct the second modulated signal out of the mixer into the second transceiver.

Example 5 includes the multiplexing transverter of any of Examples 1-4, wherein the frequency converter is configured to convert frequencies such that the output signal and the input signal are out of band relative to the modulated composite beamformer signal.

Example 6 includes the multiplexing transverter of any of Examples 1-5, wherein in operation, the first composite signal is transmitted on a single wire of the serial coupling, and the second composite signal is received on the single wire of the serial coupling.

Example 7 includes the multiplexing transverter of any of Examples 1-6, wherein the first serial bit stream is received from an anti-jamming (AJ) global navigation satellite system (GNSS) receiver, the second serial bit stream is provided to the AJ GNSS receiver, and the beamformed data streams are received from the AJ GNSS receiver.

Example 8 is a multiplexing transverter comprising: a first transceiver configured to demodulate a first modulated signal to generate a first serial bit stream; a second transceiver configured to modulate a second serial bit stream to generate a second modulated signal; a frequency converter configured to frequency convert an input signal to generate the first modulated signal and to frequency convert the second modulated signal to generate an output signal; a third transceiver configured to demodulate a modulated composite beamformer signal and to deserialize the demodulated composite beamformer signal to generate beamformed data streams; and a bias-tee circuit configured to sum the output signal and a direct current voltage into a first composite signal for transmission over a serial coupling, and to extract the input signal and the modulated composite beamformer signal from a second composite signal received on the serial coupling.

Example 9 includes the multiplexing transverter of Example 8, wherein the first serial bit stream comprises encoded beamformer status and the second serial bit stream comprises encoded beamformer control parameters.

Example 10 includes the multiplexing transverter of Examples 8 or 9, wherein the first transceiver is configured to perform frequency shift keying (FSK) demodulation on the first modulated signal, the second transceiver is configured to perform FSK modulation on the second serial bit stream, and the third transceiver is configured to perform non-return-to-zero (NRZ) demodulation on the modulated composite beamformer signal.

Example 11 includes the multiplexing transverter of any of Examples 8-10, further comprising: a combiner/splitter configured to direct the first modulated signal out of a mixer of the frequency converter into the first transceiver and to direct the second modulated signal from the second transceiver into the mixer.

Example 12 includes the multiplexing transverter of any of Examples 8-11, wherein the frequency converter is configured to convert frequencies such that the output signal and the input signal are out of band relative to the modulated composite beamformer signal.

Example 13 includes the multiplexing transverter of any of Examples 8-12, wherein in operation, the first composite signal is transmitted on a single wire of the serial coupling, and the second composite signal is received on the single wire of the serial coupling.

Example 14 includes the multiplexing transverter of any of Examples 8-13, wherein the first serial bit stream is provided to a navigational guidance system, the second serial bit stream is received from to the navigational guidance system, and the beamformed data streams are provided to the navigational guidance system.

Example 15 includes the multiplexing transverter of any of Examples 8-14, comprising a clock recovery circuit configured to extract a clock signal from the beamformed data streams for use by the frequency converter to synthesize a local oscillator mixing signal.

Example 16 is an interface system comprising: a first multiplexing transverter configured to provide full duplex communication over a serial coupling to a second multiplexing transverter, the communication comprising transmission of encoded beamformer status and beamformed data streams, and reception of encoded beamformer control parameters and a direct current (DC) voltage; and the second multiplexing transverter configured to provide full duplex communication over the serial coupling, the communication comprising reception of the encoded beamformer status and the beamformed data streams, and transmission of the encoded beamformer control parameters and the DC voltage.

Example 17 includes the interface system of Example 16, wherein the first multiplexing transverter comprises: a first transceiver configured to modulate a first serial bit stream to generate a first modulated signal, wherein the first serial bit stream comprises the encoded beamformer status; a second transceiver configured to demodulate a second modulated signal to generate a second serial bit stream, wherein the second serial bit stream comprises the encoded beamformer control parameters; a frequency converter configured to frequency convert the first modulated signal to generate an output signal and to frequency convert an input signal to generate the second modulated signal; a third transceiver configured to serialize the beamformed data streams and to modulate the serialized streams to generate a modulated composite beamformer signal; and a bias-tee circuit configured to sum the output signal and the modulated composite beamformer signal into a first composite signal for transmission over the serial coupling; and to extract the input signal and the DC voltage from a second composite signal received on the serial coupling.

Example 18 includes the interface system of Examples 16 or 17, wherein the second multiplexing transverter comprises: a first transceiver configured to demodulate a first modulated signal to generate a first serial bit stream wherein the first serial bit stream comprises the encoded beamformer status; a second transceiver configured to modulate a second serial bit stream to generate a second modulated signal, wherein the second serial bit stream comprises the encoded beamformer control parameters; a frequency converter configured to frequency convert an input signal to generate the first modulated signal and to frequency convert the second modulated signal to generate an output signal; a third transceiver configured to demodulate a modulated composite beamformer signal and to deserialize the demodulated composite beamformer signal to generate the beamformed data streams; and a bias-tee circuit configured to sum the output signal and the direct current voltage into a first composite signal for transmission over the serial coupling; and to extract the input signal and the modulated composite beamformer signal from a second composite signal received on the serial coupling.

Example 19 includes the interface system of any of Examples 16-18, wherein the serial coupling is a coaxial cable that includes a center conductor on which full duplex communication data is exchanged by the first and second multiplexing transverters.

Example 20 includes the interface system of any of Examples 16-19, wherein the encoded beamformer status and the beamformed data streams are received from an anti-jamming (AJ) global navigation satellite system (GNSS) receiver, and the encoded beamformer control parameters are received from a navigational guidance system.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A multiplexing transverter comprising:
a first transceiver configured to modulate a first serial bit stream to generate a first modulated signal;
a second transceiver configured to demodulate a second modulated signal to generate a second serial bit stream;
a frequency converter configured to frequency convert the first modulated signal to generate an output signal and to frequency convert an input signal to generate the second modulated signal;
a third transceiver configured to serialize beamformed data streams and to modulate the serialized streams to generate a modulated composite beamformer signal; and
a bias-tee circuit configured to sum the output signal and the modulated composite beamformer signal into a first composite signal for transmission over a serial coupling, and to extract the input signal and a direct current voltage from a second composite signal received on the serial coupling.

2. The multiplexing transverter of claim 1, wherein the first serial bit stream comprises encoded beamformer status and the second serial bit stream comprises encoded beamformer control parameters.

3. The multiplexing transverter of claim 1, wherein the first transceiver is configured to perform frequency shift keying (FSK) modulation on the first serial bit stream, the second transceiver is configured to perform FSK demodulation on the second modulated signal, and the third transceiver is configured to perform non-return-to-zero (NRZ) modulation on the serialized streams.

4. The multiplexing transverter of claim 1, further comprising: a combiner/splitter configured to direct the first modulated signal from the first transceiver into a mixer of the frequency converter, and to direct the second modulated signal out of the mixer into the second transceiver.

5. The multiplexing transverter of claim 1, wherein the frequency converter is configured to convert frequencies such that the output signal and the input signal are out of band relative to the modulated composite beamformer signal.

6. The multiplexing transverter of claim 1, wherein in operation, the first composite signal is transmitted on a single wire of the serial coupling, and the second composite signal is received on the single wire of the serial coupling.

7. The multiplexing transverter of claim 1, wherein the first serial bit stream is received from an anti-jamming (AJ) global navigation satellite system (GNSS) receiver, the second serial bit stream is provided to the AJ GNSS receiver, and the beamformed data streams are received from the AJ GNSS receiver.

8. A multiplexing transverter comprising:
a first transceiver configured to demodulate a first modulated signal to generate a first serial bit stream;
a second transceiver configured to modulate a second serial bit stream to generate a second modulated signal;
a frequency converter configured to frequency convert an input signal to generate the first modulated signal and to frequency convert the second modulated signal to generate an output signal;
a third transceiver configured to demodulate a modulated composite beamformer signal and to deserialize the demodulated composite beamformer signal to generate beamformed data streams; and
a bias-tee circuit configured to sum the output signal and a direct current voltage into a first composite signal for transmission over a serial coupling, and to extract the input signal and the modulated composite beamformer signal from a second composite signal received on the serial coupling.

9. The multiplexing transverter of claim 8, wherein the first serial bit stream comprises encoded beamformer status and the second serial bit stream comprises encoded beamformer control parameters.

10. The multiplexing transverter of claim 8, wherein the first transceiver is configured to perform frequency shift keying (FSK) demodulation on the first modulated signal, the second transceiver is configured to perform FSK modulation on the second serial bit stream, and the third transceiver is configured to perform non-return-to-zero (NRZ) demodulation on the modulated composite beamformer signal.

11. The multiplexing transverter of claim 8, further comprising: a combiner/splitter configured to direct the first modulated signal out of a mixer of the frequency converter into the first transceiver and to direct the second modulated signal from the second transceiver into the mixer.

12. The multiplexing transverter of claim 8, wherein the frequency converter is configured to convert frequencies such that the output signal and the input signal are out of band relative to the modulated composite beamformer signal.

13. The multiplexing transverter of claim 1, wherein in operation, the first composite signal is transmitted on a single wire of the serial coupling, and the second composite signal is received on the single wire of the serial coupling.

14. The multiplexing transverter of claim 1, wherein the first serial bit stream is provided to a navigational guidance system, the second serial bit stream is received from to the navigational guidance system, and the beamformed data streams are provided to the navigational guidance system.

15. The multiplexing transverter of claim 1, comprising a clock recovery circuit configured to extract a clock signal from the beamformed data streams for use by the frequency converter to synthesize a local oscillator mixing signal.

16. An interface system comprising:
a first multiplexing transverter configured to provide full duplex communication over a serial coupling to a second multiplexing transverter, the communication comprising transmission of encoded beamformer status and beamformed data streams, and reception of encoded beamformer control parameters and a direct current (DC) voltage; and
the second multiplexing transverter configured to provide full duplex communication over the serial coupling, the communication comprising reception of the encoded beamformer status and the beamformed data streams, and transmission of the encoded beamformer control parameters and the DC voltage.

17. The interface system of claim 16, wherein the first multiplexing transverter comprises:
a first transceiver configured to modulate a first serial bit stream to generate a first modulated signal, wherein the first serial bit stream comprises the encoded beamformer status;
a second transceiver configured to demodulate a second modulated signal to generate a second serial bit stream, wherein the second serial bit stream comprises the encoded beamformer control parameters;
a frequency converter configured to frequency convert the first modulated signal to generate an output signal and to frequency convert an input signal to generate the second modulated signal;
a third transceiver configured to serialize the beamformed data streams and to modulate the serialized streams to generate a modulated composite beamformer signal; and
a bias-tee circuit configured to sum the output signal and the modulated composite beamformer signal into a first composite signal for transmission over the serial coupling; and to extract the input signal and the DC voltage from a second composite signal received on the serial coupling.

18. The interface system of claim 16, wherein the second multiplexing transverter comprises:
a first transceiver configured to demodulate a first modulated signal to generate a first serial bit stream wherein the first serial bit stream comprises the encoded beamformer status;
a second transceiver configured to modulate a second serial bit stream to generate a second modulated signal, wherein the second serial bit stream comprises the encoded beamformer control parameters;
a frequency converter configured to frequency convert an input signal to generate the first modulated signal and to frequency convert the second modulated signal to generate an output signal;
a third transceiver configured to demodulate a modulated composite beamformer signal and to deserialize the demodulated composite beamformer signal to generate the beamformed data streams; and
a bias-tee circuit configured to sum the output signal and the direct current voltage into a first composite signal for transmission over the serial coupling; and to extract the input signal and the modulated composite beamformer signal from a second composite signal received on the serial coupling.

19. The interface system of claim 16, wherein the serial coupling is a coaxial cable that includes a center conductor on which full duplex communication data is exchanged by the first and second multiplexing transverters.

20. The interface system of claim 16, wherein the encoded beamformer status and the beamformed data streams are received from an anti-jamming (AJ) global navigation satellite system (GNSS) receiver, and the encoded beamformer control parameters are received from a navigational guidance system.
